(19) United States
(12) Patent Application Publication
(10) Pub. No.: US 2021/0048858 A1
(43) Pub. Date: Feb. 18, 2021

(54) ELECTRONIC DISPLAY

(71) Applicant: Creedon Technologies HK Limited, Sheung Wan (CN)

(72) Inventors: Mark Creedon PALFREEMAN, Los Altos, CA (US); Marcin Wojciech DUDAR, Ma Wan (HK); So Sum TANG, Shau Kei Wan (HK); Lawrence Chun Hei CHU, Yuen Long (HK)

(21) Appl. No.: 16/542,700

(22) Filed: Aug. 16, 2019

(51) Int. Cl. G06F 1/18; A47G 1/06; G06F 3/147

(52) U.S. Cl. CPC G06F 1/189; G06F 3/147; A47G 1/065

(57) ABSTRACT

An electronic display includes a screen for displaying digital content, an electronic operating circuit for operating the screen, a support supporting the screen and the operating circuit, and a stand. The support has a recess and includes a positioner for positioning the support in a standing position, in which the support stands on a surface, and a hung position, in which the support is hung on a surface. The stand has an engagement part engageable with the positioner for standing the support in the standing position. The stand includes a first electrical connector for connecting the operating circuit to a power source. The electronic display also includes a second electrical connector for connecting the operating circuit to a power source. The second electrical connector includes an electrical connecting unit for use in the hung position, with the positioner engaging an engaging element on a surface from which the support is hung.

### TECHNICAL FIELD

The present invention relates to an electronic display.

### BACKGROUND

A photo frame generally includes a frame holding an image and a stand supporting the frame in one orientation. Recently, digital photo frames have been drawing attentions due to its capability to display a large number of images, or even videos containing sounds.

Conventional digital photo frames usually include, in addition to the frame and the stand, an electrical connector connecting the photo frame to a power source for operation. However, the non-removable stand and the individual electrical connector may limit the applications of the digital photo frame.

### SUMMARY OF THE INVENTION

It is an object of the invention to address the above needs, to overcome or substantially ameliorate the above disadvantages or, more generally, to provide a new or otherwise improved electronic display.

According to an aspect of the present invention, there is provided an electronic display comprising a screen for displaying digital content, an electronic operating circuit for operating the screen, a support supporting the screen and the operating circuit, and a stand. The support has a recess and includes engaging means for use in positioning of the support in one of a standing position in which the support stands on a surface and a hung position in which the support is hung on a surface. The stand has an engagement part engageable with the engaging means for standing the support on a surface in the standing position. The stand includes a first electrical connecting means for connecting the operating circuit to a power source. The electronic display also includes a second electrical connecting means for connecting the operating circuit to a power source. The second electrical connecting means includes an electrical connecting unit for use in the recess of the support in the hung position, with the engaging means engaging an engaging element on a surface from which the support is hung.

Preferably, the engagement part comprises a cover and at least one engaging part on the cover and engageable with the engaging means.

More preferably, said at least one engaging part comprises a hooking part.

Additionally or alternatively, the cover is adapted to cover the recess when the support is in the standing position.

Preferably, the cover is adapted to cover the engaging means when the support is in the standing position.

Preferably, the recess is adapted to receive the whole electrical connecting unit when the support is in the hung position.

Preferably, the engaging means comprises at least one hole.

More preferably, said at least one hole has a periphery having a part inter-engageable selectively with the engagement part of the stand when the support is in the standing position or with an engaging element on a surface from which the support is hung.

More preferably, said at least one hole comprises a keyhole.

Preferably, the engaging means is provided on at least opposite sides of the recess.

Preferably, the stand has an elongated body which is bendable and is adapted to stay bent and internally along which the first electrical connecting means extends.

More preferably, the first electrical connecting means includes a first electrical connector exposed at a far end of the stand relative to the support for electrical connection to a power source.

More preferably, the first electrical connecting means includes a second electrical connector at a near end of the stand relative to the support for electrical connection to the operating circuit.

Yet more preferably, the engagement part is provided at the near end of the stand alongside the second electrical connector.

Preferably, the second electrical connecting means includes a flat cable which is connected at one end with the electrical connecting unit, is connectable at the other end to a power source, and lies flat against the support when the electrical connecting unit is used in the recess of the support in the hung position.

Preferably, the recess is provided internally with a third electrical connector (socket) connected to the operating circuit, for connection selectively with the first electrical connecting means of the stand when the support is in the standing position or with the electrical connecting unit of the second electrical connecting means when the support is in the hung position.

Preferably, the operating circuit includes a wireless receiver for receiving digital content from a remote source and an image processor for processing the received digital content to be displayed on the screen.

Preferably, the digital content comprises still images, video images and sound.

Preferably, the electronic display comprises an electronic photo frame.

### BRIEF DESCRIPTION OF DRAWINGS

Embodiment of the invention will now be described, by way of example, with reference to the accompanying drawings in which:

FIG. 1A is a front view of an electronic display according to one embodiment of the present invention, having a screen and a support supporting the screen;

FIG. 1B is a rear view of the support of the electronic display of FIG. 1A;

FIG. 2 is a perspective view of a stand of the electronic display of FIG. 1A;

FIG. 3 is a rear perspective view of the electronic display of FIG. 1A including the stand of FIG. 2;

FIG. 4A is a rear view of the electronic display of FIG. 3, using the stand;

FIG. 4B is a cross-sectional side view of the electronic display of FIG. 4A, showing the mechanical connection between the support and the stand;

FIG. 5 is a cross-sectional side view of the electronic display of FIG. 4A, showing the electrical connection between the support and the stand;

FIG. 6A is a rear perspective view of the electronic display of FIG. 1A, using a second electrical connecting means for power connection;

FIG. 6B is a rear perspective view of the electronic display of FIG. 6A, showing the connection of the second electrical connecting means to the support;

FIG. 7A is a perspective view of an upper terminal of the second electrical connecting means of FIG. 6A;

FIG. 7B is a top plan view of the upper terminal of FIG. 7A;

FIG. 7C is a perspective view of a lower terminal of the second electrical connecting means of FIG. 6A;

FIG. 7D is a bottom plan view of the lower terminal of FIG. 7C;

FIG. 8A is a rear perspective view of the electronic display of FIG. 1A, using a power cable for power connection; and

FIG. 8B is a cross-sectional side view of the electronic display of FIG. 8A, showing the connection of the power cable to the support.

### DETAILED DESCRIPTION OF PREFERRED EMBODIMENT

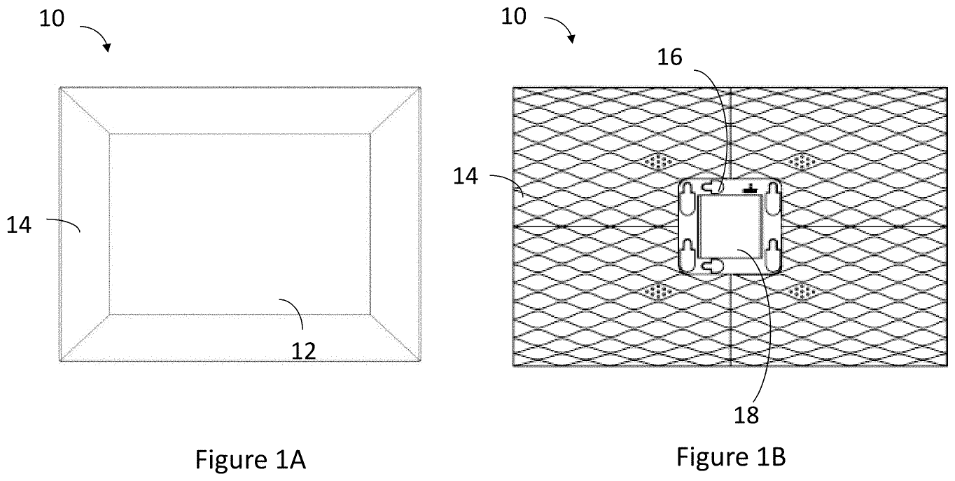

With reference to FIGS. 1 to 8B of the drawings, there is shown an electronic display 10 embodying the invention, which may be used for displaying digital content, such as still images, video images and sound. Preferably and as illustrated, the electronic display is an electronic photo frame 10. More preferably, the photo frame 10 is adapted to be used with different types of standard electrical connections to facilitate its positioning in different positions, as hereinafter described.

Referring initially to FIGS. 1A and 1B, the photo frame 10 includes a screen 12 for displaying digital content, an electronic operating circuit (not shown) for operating the screen 12, and a support 14 supporting the screen 12 and the operating circuit. In the case of the photo frame 10, it is its body i.e. frame that acts as the support 14, hence also referred to as body 14. The photo frame 10 includes a speaker unit that is mounted in the body 14 and connected to the operating circuit, enabling the audio capabilities in synchronization with the display of the video images.

In the illustrated embodiment, the screen 12 is encircled by the body 14 in a way that the screen 12 is secured by the body 14.

The screen 12 may be a liquid-crystal display (LCD). Preferably, in-plane switching (IPS) technology is utilized for the screen for providing more consistent and accurate colour reproductions compared to conventional LCDs. The body 14 may be made of any suitable materials that are rigid and robust enough to support the whole screen 12 and the electronic components in the electronic operating circuit. For example, the body 14 may be made of wood, plastics or metallic materials.

The operating circuit preferably includes a wireless receiver, such as in particular a Wi-Fi module, for receiving digital content from a remote source (e.g. cloud), a memory (e.g. non-volatile memory) for storing the received digital content, and an image processor for processing the received digital content to be displayed on the screen 12.

During operation, a user may send or upload photos and videos from a smartphone to a cloud using a mobile application (app) installed on the smartphone, e.g. a dedicated app or any other supported apps such as a social media app. The digital contents may alternatively be uploaded via email. These photos and videos may then be retrieved from the cloud using the wireless receiver. Upon receiving the photos and videos and storing them in the memory of the operating circuit, the stored photos and videos may be displayed directly on the screen 12 after being processed by the image processor. Alternatively, the photos and videos may be processed and stored in the memory in the form of a playlist that may be displayed in the future without repeating the uploading and retrieving processes.

The operating circuit may also include a wireless transmitter (e.g. as part of the Wi-Fi module) for communicating data and signals to a remote device (e.g. a smartphone). For example, the wireless transmitter may transmit an identification signal of the photo frame 10 to a smartphone, allowing a wireless connection between the photo frame 10 and the smartphone, thereby permitting the operating circuit of the photo frame 10 to access the cloud associated with the smartphone. The wireless communication may also allow the smartphone to control the photo frame 10 and to manage the settings of the photo frame 10, e.g. to adjust the brightness of the screen 12. Such wireless technology may include, apart from Wi-Fi, Bluetooth or Near Field Communication (NFC) technologies.

As shown in FIG. 1B, the body 14 includes engaging means 16 for use in positioning of the body 14 in one of a standing position in which the body 14 stands on a surface (e.g. desktop) and a hung position in which the body 14 is hung on a surface (e.g. wall). The engaging means includes at least one hole 16. In the described embodiment, the engaging means includes six said holes 16, each shaped like a keyhole having a larger round end and a smaller opposite round end. A recess 18 is formed in the centre of the back of the body 14, with the holes 16 arranged on opposite sides of the recess 18. Providing the engaging means 16 at the centre of the body 14 helps balancing the whole photo frame 10 in the desired landscape or portrait orientation, when placed in the standing or hung position.

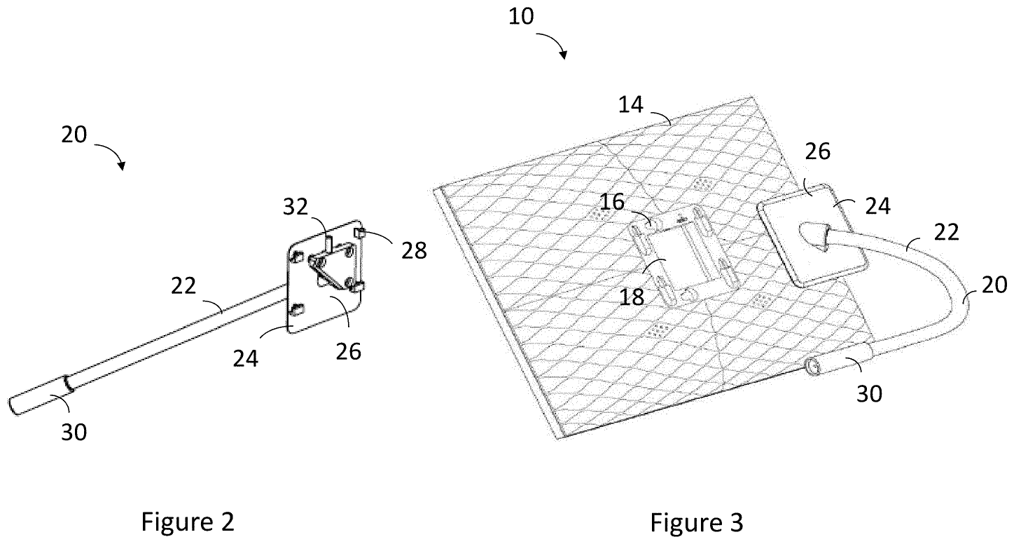

FIG. 2 shows a stand 20 of the photo frame 10, which is used for standing the body 14 on a surface, often a horizontal surface. The stand 20 has an elongated body 22 and includes engagement part 24 engageable with the engaging means 16 for standing the body 14 on a surface in the standing position. The engagement part 24 is provided at a near end of the stand 20 relative to the body 14 alongside with an electrical connector in the form of a 3.5 mm electrical plug 32. The engagement part 24 includes a cover 26 and at least one engaging part 28 on the cover 26 and engageable with the engaging means 16. The engagement part 24 is in the form of a square cover 26 supporting at its corners four hooking parts 28. Preferably, the hooking parts 28 are shaped and sized to fit the holes 16 on the body 14. The stand 20 also includes an electrical connecting means 30 for connecting the operating circuit to an external power source, e.g. DC power source, which will be discussed later.

FIG. 3 shows that the elongated body 22 is bendable and is adapted to stay bent at various curvature or angle it is bent to. This is useful for standing the photo frame 10 in various angular positions in either landscape or portrait orientation, and particularly useful when there is limited space on a uniform surface for both the body 14 and the stand 20 to stand on. For example, the body 14 may be stood on a table, while the stand 20 connected thereto may be adjusted, compacted and placed on a stepped surface, thus saving space. Since the stand 20 is bendable, the photo frame 10 may be used in landscape and portrait orientations, or any angled orientations.

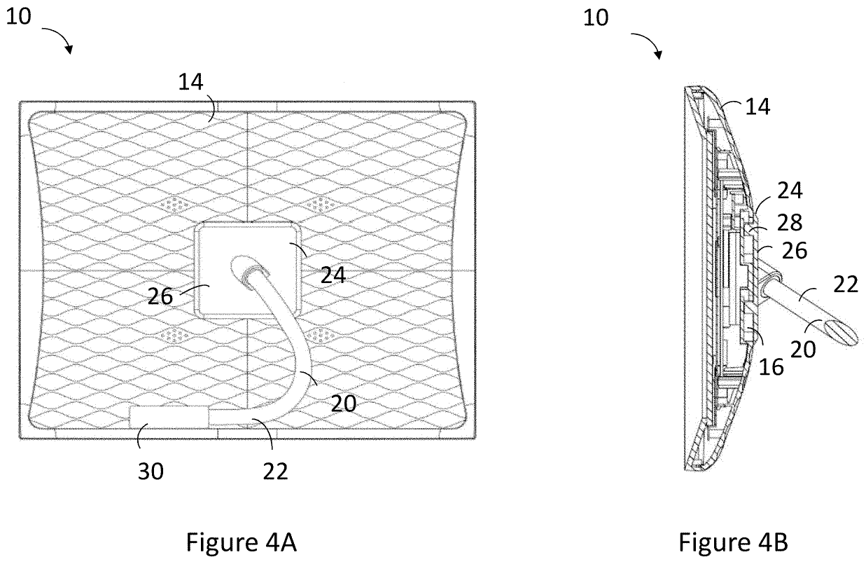

FIGS. 4A and 4B illustrate the stand 20 being engaged or received in part in the recess 18 of the body 14. The electrical plug 32 protrudes laterally from an inner block of the cover 26 (FIG. 2), which is small enough to be accommodated in the recess 18. The cover 26, which is larger in footprint than the recess 18, covers the recess 18 when the stand 20 is fitted on the body 14. Further, the cover 26 is sufficiently large to also cover and conceal the holes 16, with the hooking parts 28 engaged with the holes 16, thereby resulting in a neat appearance.

Each of the holes 16 includes, at its smaller end, a periphery having a part that is inter-engageable with the hooking part 28 of the stand 20. When a user desires to use the photo frame 10 in a standing position, the use should first insert the hooking parts 28 on the cover 26 of the stand 20 into the larger ends of the respective holes 16, and then slide the cover 26 and thus the hooking parts 28 to reach and engage with the smaller ends, latching with the same.

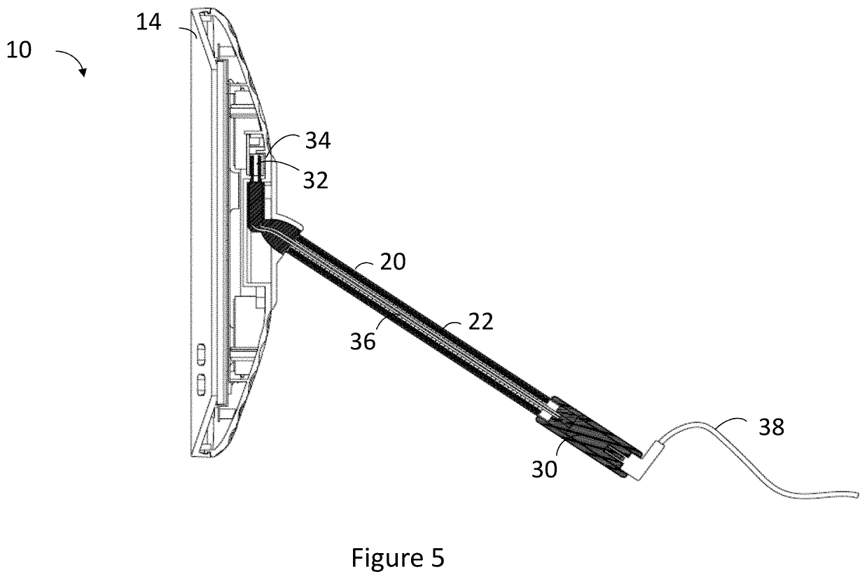

FIG. 5 shows the electrical connection between the body 14 and the stand 20. The recess 18 of the body 14 is provided internally with a third electrical connector 34 connected to the operating circuit. Preferably, the third electrical connector 34 is an electrical socket sized to receive a 3.5 mm electrical plug, i.e. the electrical plug 32.

The first electrical connecting means 36 extends internally along the stand 20, with a first electrical connector 30, preferably a female connector, exposed at a far end of the stand 20 relative to the body 14 for electrical connection to a power source, and a second electrical connector i.e. electrical plug 32 at a near end of the stand 20 relative to the body 14 for electrical connection to the operating circuit via the third electrical socket 34. Power is provided from an external power source, via the electrical connectors 30, 32 to 34 to the operating circuit.

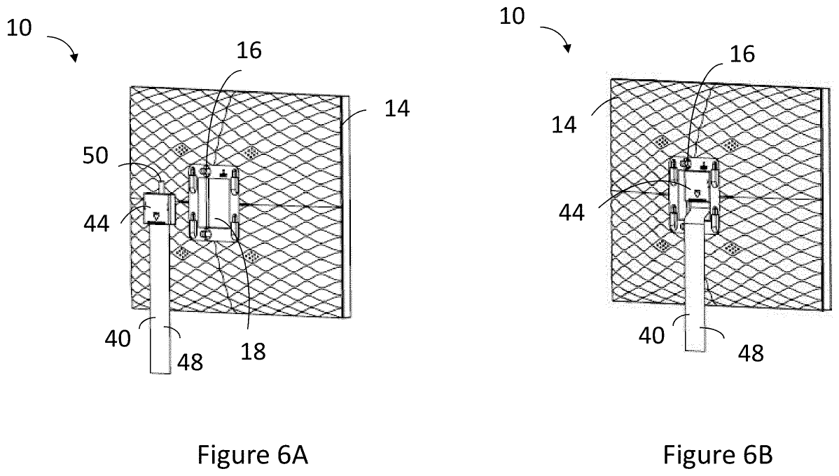

In a different scenario, if the user wants to use the photo frame 10 on a wall, which is a substantially vertical surface, he should replace the stand 20 by a second electrical connecting means 40 (FIGS. 6A and 6B).

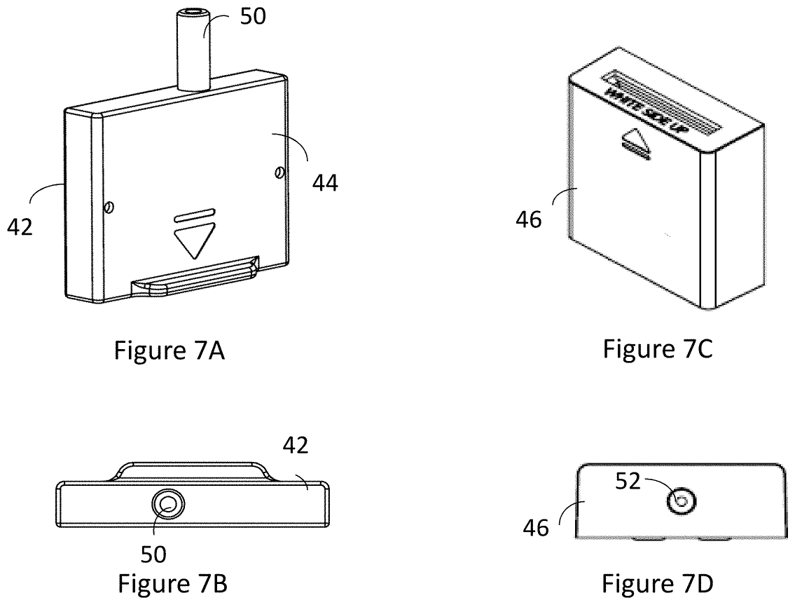

The second electrical connecting means 40 is formed by an upper terminal 42 (FIGS. 7A and 7B), a lower terminal 46 (FIGS. 7C and 7D, and a flat cable 48 extending across the upper and lower terminals 42, 46. The upper terminal 42 comprises an electrical connecting unit 44 with an electrical plug 50 protruding at the top thereof, similar to the second electrical connector 32 in FIG. 2, for connection with the electrical docket 34 in the recess 18. The lower terminal 46 includes an electrical socket 52 at the bottom for connecting a power cable from an external power source.

FIGS. 6A and 6B illustrate the photo frame 10 when located in the hung position, with the use of the second electrical connecting means 40. One of the holes 16 in the body 14 may engage an engaging element, e.g. a screw, on the wall from which the body 14 is hung. The periphery of this hole 16 has a part inter-engageable and engaged with the screw (on the wall), whereby the photo frame 10 is located in the hung position.

With the use of the second electrical connecting means 40, its upper terminal 42 is accommodated in the recess 18 of the photo frame body 14. Specifically, the recess 18 is adapted to receive the whole electrical connecting unit 44, such that the upper terminal 42 does not take up any space externally of the body 14. In addition, the flat cable 48 is rather thin and it lies flat between the body 14 and the wall. This design allows the photo frame 10 to be used on the wall, lying closest possible thereto and against it.

In general, the third electrical connector 34 in the recess 18 on the back of the body 14 is useful for connection selectively with the second electrical connecting means 32 of the stand 20 when the body 14 is in the standing position, as described earlier, or with the electrical connecting unit 44 of the second electrical connecting means 40 when the body 14 is in the hung position.

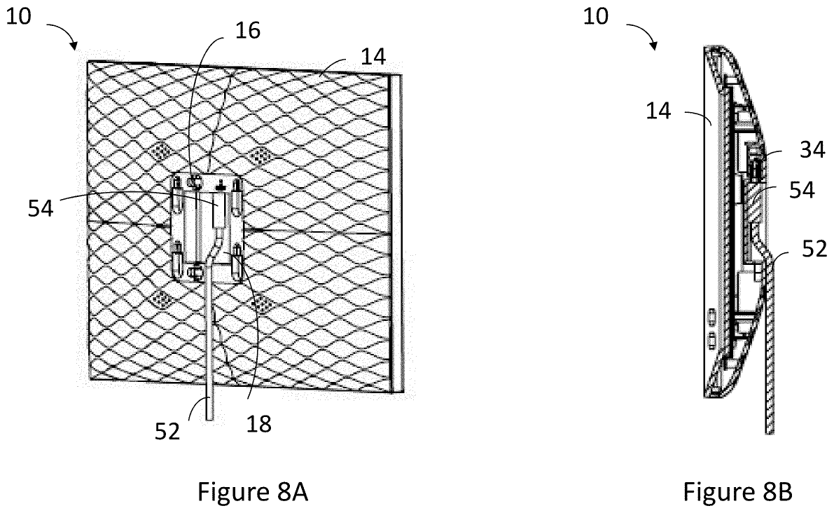

As a further option, referring to FIGS. 8A and 8B, a simple power cable 52 fitted with a 3.5 mm electrical plug 54 may be used in place of the second electrically connecting means 40. In that case, the user may simply insert the electrical plug 54 into the electrical socket 34 in the recess 18. A thin cable should be chosen for use as the power cable 52. Alternatively or additionally, a notch or recess (not shown) may be formed in the periphery of the recess 18 for the power cable 52 to pass through without adding any thickness to the photo frame 10 on the back for lying closest possible to the wall.

The present invention, as discussed above, provides an electronic display with an additional and advantageous engaging feature over the pre-existing electronic displays. The engaging means, i.e. the holes 16 in the described embodiment, of the present electronic display is capable of selectively engaging a stand for use in a standing position or an engaging element for use in a hung position.

In addition, the bendable stand 20 allows the electronic display body 14 with the screen 12 to be placed in different orientations at different angles. For example, the body 14 may be arranged in a portrait orientation. The stand 20 is arranged not only to support the screen 12 and body 14, but also to connect power from an external power source to the operating circuit of the electronic display 10 due to the provision of the integrated power connection design.

The invention has been given by way of example only, and various other modifications of and/or alterations to the described embodiment may be made by persons skilled in the art without departing from the scope of the invention as specified in the appended claims. The described components of the electronic display may be arranged in a different way. Additionally, the electronic display may include additional components for carrying out additional functions.

For example, the screen of the electronic display may not be encircled in the support, but fixed and supported on top of the support. The screen may include a touch screen that allows the user to interact directly with the electronic display without using a smartphone, for example, to select a saved playlist from the electronic display, or to change a setting of the electronic display.

In addition or as an alternative to the wireless communication between the electronic display and the cloud, the electronic display may include an interface for receiving a memory stick or card on which digital contents are stored. The image processor may be operable to process the digital contents on the memory stick or card to be displayed on the screen.

For example, the construction of the stand may vary. The cover may be a grid supporting an engagement part which may not cover the recess or the holes of the support when the stand is attached to the support. The first, second and third electrical connectors may be of other forms of electrical connectors, i.e. any forms other than a 3.5 mm male or female connector.

Additionally, keyholes and hooking parts may be of other forms of engageable couplings. For example, the pair of engageable couplings may be magnetic coupling, threaded hole and fastener, bayonet coupling, etc.

Any reference to prior art contained herein is not to be taken as an admission that the information is common general knowledge, unless otherwise indicated.

1. An electronic display comprising:
a screen for displaying digital content;
an electronic operating circuit for operating the screen;
a support supporting the screen and the operating circuit, wherein the support has a recess and includes engaging means for positioning the support in one of a standing position, in which the support stands on a first surface, and a hung position, in which the support is hung on a second surface;
a stand having an engagement part engageable with the engaging means for standing the support on the first surface in the standing position, wherein the stand includes a first electrical connecting means for connecting the operating circuit to a power source; and
a second electrical connecting means for connecting the operating circuit to a power source, wherein the second electrical connecting means includes an electrical connecting unit for use in the recess of the support in the hung position, with the engaging means engaging an engaging element on the second surface from which the support is hung.

2. The electronic display as claimed in claim 1, wherein the engagement part comprises
a cover, and
at least one engaging part on the cover and engageable with the engaging means.

3. The electronic display as claimed in claim 2, wherein the at least one engaging part comprises a hooking part.

4. The electronic display as claimed in claim 2, wherein the cover is adapted to cover the recess when the support is in the standing position.

5. The electronic display as claimed in claim 2, wherein the cover is adapted to cover the engaging means when the support is in the standing position.

6. The electronic display as claimed in claim 1, wherein the recess is adapted to receive all of the electrical connecting unit when the support is in the hung position.

7. The electronic display as claimed in claim 1, wherein the engaging means comprises at least one hole.

8. The electronic display as claimed in claim 7, wherein the at least one hole has a periphery having a part inter-engageable selectively with the engagement part of the stand when the support is in the standing position, or with an engaging element on the second surface from which the support is hung.

9. The electronic display as claimed in claim 8, wherein the at least one hole comprises a keyhole.

10. The electronic display as claimed in claim 1, wherein the engaging means is located at least on opposite sides of the recess.

11. The electronic display as claimed in claim 1, wherein the stand has an elongated body which is bendable and is adapted to stay bent and along which the first electrical connecting means extends internally.

12. The electronic display as claimed in claim 11, wherein the first electrical connecting means includes an electrical connector exposed at a remote end of the stand, which is remote relative to the support for electrical connection to a power source.

13. The electronic display as claimed in claim 11, wherein the first electrical connecting means includes an electrical connector at a proximal end of the stand, which is proximate, relative to the support for electrical connection, to the operating circuit.

14. The electronic display as claimed in claim 13, wherein the engagement part is located at the proximal end of the stand, alongside the electrical connector.

15. The electronic display as claimed in claim 1, wherein the second electrical connecting means includes a flat cable which is connected at a first end with the electrical connecting unit, is connectable at a second end to a power source, and lies flat against the support when the electrical connecting unit is in the recess of the support, when the support id in the hung position.

16. The electronic display as claimed in claim 1, wherein the recess is provided internally with an electrical connector connected to the operating circuit, for connection, selectively, with the first electrical connecting means of the stand when the support is in the standing position, or with the electrical connecting unit of the second electrical connecting means when the support is in the hung position.

17. The electronic display as claimed in claim 1, wherein the operating circuit includes
wireless receiver for receiving digital content from a remote source, and
an image processor for processing the digital content received by the wireless receiver and to be displayed on the screen.

18. The electronic display as claimed in claim 1, wherein the digital content comprises still images, video images, and sound.

19. The electronic display as claimed in claim 1, comprising an electronic photo frame.
